(19) United States
(12) Patent Application Publication
(10) Pub. No.: US 2015/0138176 A1
(43) Pub. Date: May 21, 2015

(54) SCANNING SIGNAL LINE DRIVE CIRCUIT AND DISPLAY DEVICE PROVIDED WITH SAME

(71) Applicant: Sharp Kabushiki Kaisha, Osaka-shi, Osaka (JP)

(72) Inventor: Shinsuke Yokonuma, Osaka-shi (JP)

(73) Assignee: Sharp Kabushiki Kaisha, Osaka-shi, Osaka (JP)

(21) Appl. No.: 14/397,891

(22) PCT Filed: Apr. 26, 2013
(86) PCT No.: PCT/JP2013/062364

§ 371 Date: Oct. 30, 2014

(30) Foreign Application Priority Data
May 11, 2012 (JP) 2012-109342

(51) Int. Cl. G09G 3/36

(52) U.S. Cl. CPC G09G 3/3677; G09G 3/3614; G09G 2310/0224; G09G 2310/0213; G09G 2310/0286; G09G 2330/06; G09G 2330/021
USPC 345/209; 345/208; 345/100

(57) ABSTRACT

First and second scanning signal line drive circuits provided in this liquid crystal display device perform interlacing drive. Gate clock signals, gate start pulse signals, and clear signals provided to these drive circuits are supplied through two trunk lines corresponding to two shift register circuits included in each of the drive circuits. Accordingly, when compared to a typical conventional scanning signal line drive circuit including one shift register circuit, the number of bistable circuits connected to one trunk line is halved and the clock signals have lower frequencies, whereby it is possible to further reduce power consumption.

### TECHNICAL FIELD

The present invention relates to active-matrix display devices, more specifically to a scanning signal line drive circuit in an active-matrix display device.

### BACKGROUND ART

In general liquid crystal display devices, polarity inversion drive is performed in order to suppress liquid crystal deterioration. A known polarity inversion drive scheme is a scheme (frame inversion drive scheme) in which the polarity of a voltage applied to the liquid crystal is inverted every frame. However, this drive scheme is subject to display defects, such as flicker, upon display, and therefore, in the drive schemes employed in recent years, the polarity of an applied voltage is inverted every horizontal scanning line and also every frame (a so-called “line inversion drive scheme”) or the polarity of an applied voltage is inverted every two vertically/horizontally adjacent pixels and also every frame (a so-called “dot inversion drive scheme”).

The dot inversion drive scheme uses a relatively complicated anti-flicker pattern and therefore is less prone to the occurrence of flicker, so that high-quality display can be achieved. In addition, in this scheme, a direct-current voltage is applied to the common electrode of the liquid crystal panel, resulting in less noise than in the case of a scheme in which the common electrode is driven with an alternating-current voltage.

However, in such a dot inversion drive scheme in which a direct-current voltage is provided to the common electrode, the polarity of a video signal to be applied to the liquid crystal panel is switched between predetermined voltages respectively above and below the potential of the common electrode, and therefore, the voltage swing of a video signal outputted by a liquid crystal panel driver is high, so that a specialized power supply configuration is required and power consumption tends to be high. Moreover, in the line inversion drive also, more power consumption can be reduced as the polarity inversion cycle of a video signal becomes longer (i.e., as the number of inversions per frame decreases).

Accordingly, for example, only the odd-numbered scanning lines are sequentially selected in the first field in order to output signals from a source driver, and thereafter, polarity inversion is performed, so that only the even-numbered scanning lines are sequentially selected in the next, i.e., second, field in order to output signals from the source driver, whereby line inversion drive or dot inversion drive can be realized by simply performing one polarity inverting operation per frame. Such a drive scheme is called an interlaced scanning scheme or an interlacing drive scheme.

Furthermore, recent years have seen more scanning signal line drive circuits (gate drivers) as described above being formed with amorphous silicon or suchlike on the liquid crystal panel in order to achieve cost reduction, i.e., scanning signal line drive circuits of a so-called monolithic type are increasingly employed. Such a scanning signal line drive circuit is a shift register circuit, and as the display device becomes larger and provides higher resolutions, the load connected to the output of each stage in the shift register circuit increases, resulting in increased power consumption.

Therefore, International Publication WO 2011/135879 pamphlet describes a configuration in which bistable circuits in the stages of the shift register are grouped into sets of a plurality of bistable circuits, and a group of different trunk lines (e.g., trunk lines for clock signals, power supply, etc.) is provided such that each trunk line is coupled to two or more sets of bistable circuits (hereinafter, this configuration will be referred to as the “conventional configuration”). In the conventional configuration, the number of bistable circuits connected per trunk line is significantly reduced, resulting in enhanced drive capability, as well as a significantly reduced occurrence of drive (i.e., the number of transitions to active or inactive state), whereby power consumption can be reduced.

### CITATION LIST

### Patent Document

Patent Document 1: International Publication WO 2011/135879 pamphlet

### SUMMARY OF THE INVENTION

### Problems to be Solved by the Invention

However, in the conventional configuration, the bistable circuits in the shift register are divided into first (upper) and second (lower) portions, such that these portions are driven by different trunk line groups, and therefore, it is impossible to lengthen the cycle of inverting the polarity of a video signal while maintaining display quality, and further suppress power consumption.

Therefore, an objective of the present invention is to provide a scanning line drive circuit capable of drive to reduce power consumption and a display device including the same.

### Solution to the Problems

A first aspect of the present invention is directed to a scanning signal line drive circuit for performing interlaced scanning to sequentially drive a plurality of scanning signal lines included in an active-matrix display device such that odd-numbered scanning signal lines are driven sequentially with corresponding scanning signals in a first period and even-numbered scanning signal lines are driven sequentially with corresponding scanning signals in a second period, the circuit comprising:

a first circuit group connected to a first scanning signal line group on a first-end side of the scanning signal lines divided into two groups, one being the first scanning signal line group, the other being a second scanning signal line group; and

a second circuit group connected to the second scanning signal line group on a second-end side of the scanning signal lines, wherein,

the first circuit group includes first and second shift register circuits alternatingly connected on the first-end side to the scanning signal lines included in the first scanning signal line group,

the second circuit group includes third and fourth shift register circuits alternatingly connected on the second-end side to the scanning signal lines included in the second scanning signal line group,

two of the first through fourth shift register circuits sequentially drive the odd-numbered scanning signal lines in the first period, and

the remaining two of the first through fourth shift register circuits sequentially drive the even-numbered scanning signal lines in the second period.

In a second aspect of the present invention, based on the first aspect of the invention, the first scanning signal line group includes only the odd-numbered scanning signal lines, the second scanning signal line group includes only the even-numbered scanning signal lines, the first and second shift register circuits alternatingly and sequentially drive the odd-numbered scanning signal lines in the first period, and the third and fourth shift register circuits alternatingly and sequentially drive the even-numbered scanning signal lines in the second period.

In a third aspect of the present invention, based on the second aspect of the invention, when the scanning signal lines are sequentially grouped into pairs of adjacent lines with the first pair consisting of the first and second scanning signal lines, the first scanning signal line group includes only odd-numbered pairs of scanning signal lines, the second scanning signal line group includes only even-numbered pairs of scanning signal lines, the first and third shift register circuits alternatingly and sequentially drive the odd-numbered scanning signal lines in the first period, and the second and fourth shift register circuits alternatingly and sequentially drive the even-numbered scanning signal lines in the second period.

In a fourth aspect of the present invention, based on the second or third aspect of the invention, the first through fourth shift register circuits are externally provided with either control signals or power supply potentials or both through respectively different wiring lines.

In a fifth aspect of the present invention, based on the first aspect of the invention, the scanning signal lines are integrally formed with the first and second circuit groups on the same substrate.

A sixth aspect of the present invention is directed to an active-matrix display device, comprising:

a scanning signal line drive circuit of claim 1;

a plurality of video signal lines arranged so as to cross the scanning signal lines;

a plurality of pixel forming portions arranged in a matrix corresponding to intersections of the video signal lines and the scanning signal lines; and

a video signal line drive circuit for driving the video signal lines to transmit data signals to the pixel forming portions, wherein,

the video signal line drive circuit drives the video signal lines such that voltages provided to the video signal lines are inverted in polarity between the first and second periods.

### Effect of the Invention

In the first aspect of the present invention, the first and second shift register circuits included in the first circuit group and the third and fourth shift register circuits included in the second circuit group are driven individually in order to realize interlaced scanning, so that the number of bistable circuits serving as stages of each shift register can be reduced, and typically, clock signals for the drive have lower frequencies, whereby it is possible to further reduce power consumption and suppress the influence of electromagnetic interference (EMI).

In the second aspect of the present invention, in principle, it is possible to keep the first and second shift register circuits from operating during the operation of the third and fourth shift register circuits, and similarly it is also possible to keep the third and fourth shift register circuits from operating during the operation of the first and second shift register circuits, whereby it is possible to further reduce power consumption.

In the third aspect of the present invention, the first and third shift register circuits are driven alternatingly, and the second and fourth shift register circuits are also driven alternatingly, so that the positions of the bistable circuits in operation are dispersed in each shift register circuit, and therefore, it is possible to further suppress the influence of electromagnetic interference (EMI).

In the fourth aspect of the present invention, the first through fourth shift register circuits are provided with either control signals or power supply potentials or both through respectively different wiring lines, so that typically, the number of bistable circuits connected to one trunk line is reduced, and clock signals have lower frequencies, whereby it is possible to further reduce power consumption and suppress the influence of electromagnetic interference (EMI).

In the fifth aspect of the present invention, the scanning signal line drive circuits are “monolithically” formed on the substrate, and therefore, it is possible to reduce power consumption without increasing the wiring area (and the frame area) significantly.

The sixth aspect of the present invention allows a display device to achieve the same effects as those achieved by the first aspect. In addition, it is rendered possible to perform so-called n-dot inversion drive readily and keep video signal polarity inversion down to once every frame while realizing higher display quality, and this also contributes to reduced power consumption.

### BRIEF DESCRIPTION OF THE DRAWINGS

FIG. 1 is a block diagram illustrating the configuration of a liquid crystal display device according to a first embodiment of the present invention.

FIG. 2 is a block diagram illustrating the configuration of a display control circuit in the embodiment.

FIG. 3 is a schematic diagram describing the basic configuration of a liquid crystal panel in the embodiment.

FIG. 4 is an equivalent circuit diagram of a part of the liquid crystal panel in the embodiment.

FIG. 5 is a block diagram illustrating in detail the configuration of a first scanning signal line drive circuit in the embodiment.

FIG. 6 provides waveform charts for signals related to the first scanning signal line drive circuit 401 in the embodiment.

FIG. 7 is a diagram describing the selection and connections of scanning signal lines in the embodiment as well as the relationship with the signals.

FIG. 8 is a diagram describing an operation in one-dot inversion drive in the embodiment.

FIG. 9 is a diagram describing the selection and connections of scanning signal lines in a second embodiment of the present invention as well as the relationship with signals.

FIG. 10 is a diagram describing an operation in three-dot inversion drive in a third embodiment of the present invention.

### MODES FOR CARRYING OUT THE INVENTION

Hereinafter, embodiments of the present invention will be described with reference to the accompanying drawings.

### 1. First Embodiment

<1.1 Overall Configuration and Operation>

FIG. 1 is a block diagram illustrating the configuration of a liquid crystal display device according to an embodiment of the present invention. This liquid crystal display device includes a display control circuit 200, a video signal line drive circuit (also referred to as a “source driver circuit” or a “column electrode drive circuit”) 300, first and second scanning signal line drive circuits (these circuits are also referred to as “gate driver circuits” or “row electrode drive circuits”) 401 and 402, and an active-matrix liquid crystal panel 500.

Among the above circuits, the first and second scanning signal line drive circuits 401 and 402 are integrally (i.e., monolithically) formed with pixel circuits to be described later on an element substrate, which is a glass substrate, and the display control circuit 200 and the video signal line drive circuit 300 are formed in IC chips and attached to the element substrate. A liquid crystal layer is sealed between the element-side substrate and an opposing-side substrate. In such a case where circuits are monolithically formed on a glass substrate, there are more severe design limitations on line width, etc., than in the case where the circuits are provided in the form of chips, and therefore, it is necessary to reduce more circuit area.

The liquid crystal panel 500, which functions as a display portion of the liquid crystal display device, includes a plurality of scanning signal lines (row electrodes), which respectively correspond to horizontal scanning lines for an image represented by image data Dv received from a CPU or suchlike of an external computer, a plurality of video signal lines (column electrodes) crossing each of the scanning signal lines, and a plurality of pixel forming portions provided respectively corresponding to the intersections of the scanning signal lines and the video signal lines. The configuration of each pixel forming portion is basically the same as in conventional active-matrix liquid crystal panels, except for the connecting relationship between the scanning signal lines and the scanning signal line drive circuits 401 and 402 (details will be described later).

In the present embodiment, (narrow) image data representing an image to be displayed on the liquid crystal panel 500 and data for determining the timing of a display operation or suchlike (e.g., data specifying the frequency of a display clock; referred to below as “display control data”) are transmitted from the CPU or suchlike of the external computer to the display control circuit 200 (hereinafter, such externally transmitted data Dv will be referred to as “broad image data”). That is, the external CPU or suchlike supplies the display control circuit 200 with the (narrow) image data and the display control data included in the broad image data Dv as well as an address signal ADw, so that the data and the signal are written respectively to display memory and a register, which will be described later, in the display control circuit 200.

On the basis of the display control data written in the register, the display control circuit 200 generates various signals, including a source clock signal SCK and a source start pulse signal SSP, which are provided to the video signal line drive circuit 300 for display, as well as gate signals GS1 and GS2, which are provided to the first and second scanning signal line drive circuits 401 and 402, respectively, for display. Among these signals, the source clock signal SCK and the source start pulse signal SSP are known, and therefore, any detailed descriptions thereof will be omitted; the gate signals GS1 and GS2 provided to the first and second scanning signal line drive circuits 401 and 402 include similarly known gate clock signals and gate start pulse signals, but these signals will be described in detail later. Moreover, the display control circuit 200 reads the (narrow) image data written in the display memory by the external CPU or suchlike, and outputs the data as digital image signals Da. Note that the number of signal lines provided to supply the digital image signals Da from the display control circuit 200 to the video signal line drive circuit 300 corresponds to the number of tones in images to be displayed.

In this manner, the video signal line drive circuit 300 is supplied with the data representing an image to be displayed on the liquid crystal panel 500, which is provided in units of a pixel as a series of digital image signals Da, as well as the source clock signal SCK and the source start pulse signal SSP, which are provided as signals specifying timings. On the basis of the digital image signals Da, the source clock signal SCK, and the source start pulse signal SSP, the video signal line drive circuit 300 generates video signals for driving the liquid crystal panel 500 (also referred to below as “drive video signals”), and applies them to the video signal lines of the liquid crystal panel 500.

Specifically, the video signal line drive circuit 300 includes a shift register circuit for receiving the source clock signal SCK and the source start pulse signal SSP outputted by the display control circuit 200 and outputting predetermined sampling pulses, a data latch circuit for receiving the digital image signals Da outputted by the display control circuit 200 as well as the sampling pulses, and latching data specifying pixel values included in the digital image signals Da, a level shifter circuit for shifting voltages for the data latched by the data latch circuit, a D/A conversion circuit for converting the digital data for which the voltages have been shifted by the level shifter circuit into analog voltage signals, and an output buffer circuit for applying the analog voltage signals from the D/A conversion circuit to their corresponding video signal lines Ls. These components are the same as in conventional video signal line drive circuits.

The first scanning signal line drive circuit 401 is connected to the odd-numbered scanning signal lines of the liquid crystal panel 500, and the second scanning signal line drive circuit 402 is connected to the even-numbered scanning signal lines of the liquid crystal panel 500.

Initially, on the basis of a gate signal GS1, the first scanning signal line drive circuit 401 generates scanning signals G (1), G (3), G (5), and so on, which are applied to every other scanning signal line, i.e., the odd-numbered scanning signal lines, of the liquid crystal panel 500 in order to sequentially select each of the odd-numbered scanning signal lines for one horizontal scanning period. Subsequently, on the basis of a gate signal GS2, the second scanning signal line drive circuit 402 generates scanning signals G (2), G (4), G (6), and so on, which are applied to the even-numbered scanning signal lines, in order to sequentially select each of the even-numbered scanning signal lines. In this manner, the application of active scanning signals to the scanning signal lines in order to sequentially select every other scanning signal line is repeated in cycles of one vertical scanning period through all of the scanning signal lines. Such a scanning scheme is called an interlacing drive scheme or an interlaced scanning scheme.

In the liquid crystal panel 500, the video signal line drive circuit 300 applies the drive video signals S (1), S (2), S (3), and so on based on the digital image signals Da to the video signal lines in the above manner, and the first and second scanning signal line drive circuits 401 and 402 apply the scanning signals G (1), G (2), G (3), and so on to the scanning signal lines. As a result, the liquid crystal panel 500 displays the image represented by the image data Dv received from the external CPU or suchlike.

<1.2 Display Control Circuit>

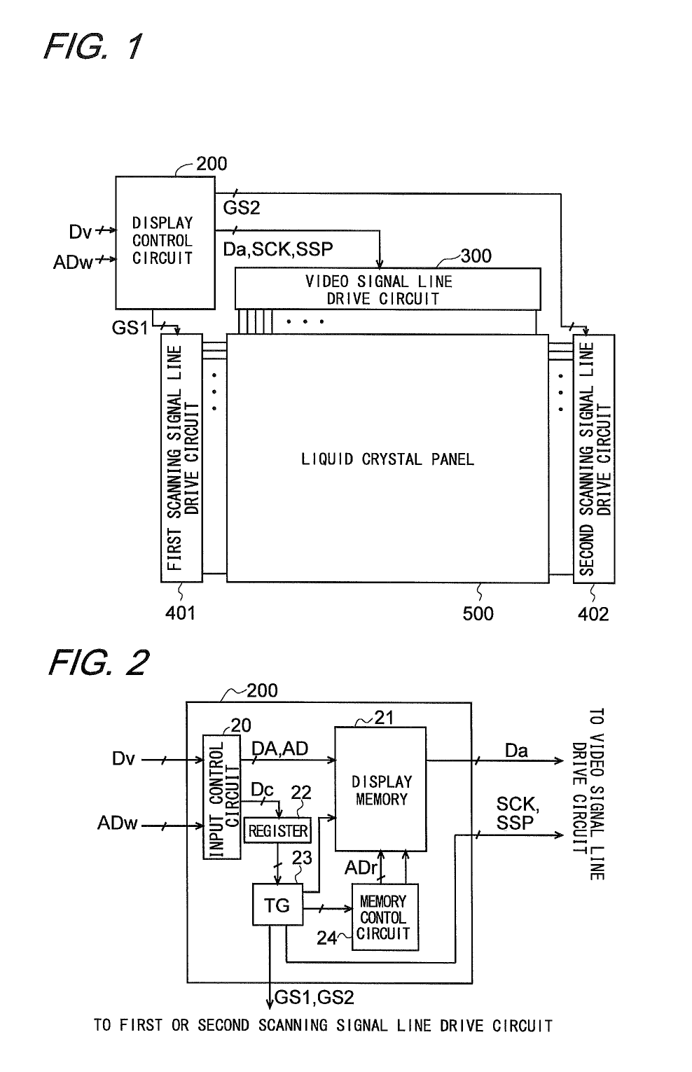

FIG. 2 is a block diagram illustrating the configuration of the display control circuit 200 in the liquid crystal display device. The display control circuit 200 includes input control memory 20, display memory 21, a register 22, a timing generation circuit 23, and a memory control circuit 24.

The image data Dv and the address signals ADw that the display control circuit 200 receives from an external video source are sorted into image data DA and display control data Dc by the input control circuit 20, so that the image data DA is written in the display memory 21, and the display control data Dc is written in the register 22.

On the basis of the display control data being held in the register 22, the timing generation circuit (abbreviated below as “TG”) 23 generates a source clock signal SCK, a source start pulse signal SSP, gate signals GS1 and GS2, and other timing signals.

The memory control circuit 24 controls the operation of the display memory 21. In accordance with the control, digital image signals Da representing an image to be displayed on the liquid crystal panel 500 are read from the display memory 21 and outputted from the display control circuit 200. The digital image signals Da are supplied to the video signal line drive circuit 300, as has already been described. Although not shown in the figure, the display control circuit 200 generates well-known control signals to determine the timing of polarity inversion for driving the liquid crystal panel 500 with an alternating-current voltage.

<1.3 Liquid Crystal Panel>

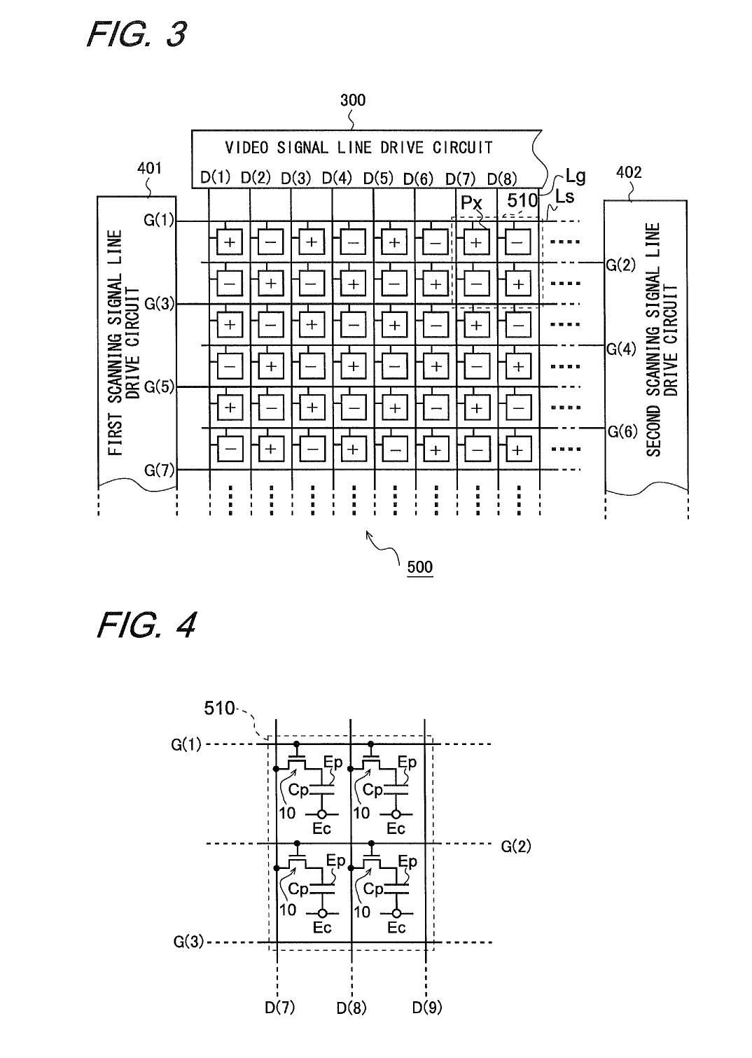

FIG. 3 is a schematic diagram illustrating the configuration of the liquid crystal panel 500 in the present embodiment, and FIG. 4 is an equivalent circuit diagram of a part (a portion corresponding to four pixels) 510 of the liquid crystal panel.

The liquid crystal panel 500 includes a plurality of video signal lines Ls connected to the video signal line drive circuit 300 and a plurality of scanning signal lines Lg connected to the first and second scanning signal line drive circuits 401 and 402, and the video signal lines Ls and the scanning signal lines Lg are arranged in a grid-like fashion so as to cross each other. In addition, a plurality of pixel forming portions Px are provided corresponding to the intersections of the video signal lines Ls and the scanning signal lines Lg. As shown in FIG. 4, each pixel forming portion Px includes a TFT (Thin Film Transistor) 10, which has a source terminal connected to a video signal line Ls passing through its corresponding intersection and a gate terminal connected to a scanning signal line Lg passing through the corresponding intersection, a pixel electrode Ep connected to a drain terminal of the TFT 10, a common electrode (also referred to as an “opposing electrode”) Ec commonly provided for the pixel forming portions Px, and a liquid crystal layer commonly provided for the pixel forming portions Px between the pixel electrode Ep and the common electrode Ec. Moreover, the pixel electrode Ep, the common electrode Ec, and the liquid crystal layer provided therebetween form pixel capacitance Cp. Note that as can be appreciated from the above configuration, once a scanning signal G (k) applied to any one of the scanning signal lines Lg becomes active, the TFTs 10 (of the pixel forming portions Px) connected to the scanning signal line are rendered conductive, so that a drive video signal D (j) is applied to the pixel electrodes Ep connected to the TFTs 10, through the video signal lines Ls. As a result, the voltage of the applied drive video signal D (j) (relative to the potential of the common electrode Ec) is written in each of the pixel forming portions Px that include the pixel electrodes Ep as a pixel value.

The pixel forming portions Px as above are arranged in a matrix to constitute a pixel formation matrix, and correspondingly, the pixel electrodes Ep included in the pixel forming portions Px are arranged in a matrix as well to constitute a pixel electrode matrix. Incidentally, the pixel electrodes Ep, which are the main parts of the pixel forming portions Px, are in one-to-one correspondence with the pixels in an image displayed on the liquid crystal panel and therefore can be considered the same as the pixels. Accordingly, for convenience of explanation, the pixel forming portions Px or the pixel electrodes Ep will be considered below the same as pixels, and the “pixel formation matrix” or the “pixel electrode matrix” will also be referred to simply as the “pixel matrix”.

In FIG. 3, the symbol “+” assigned to pixel forming portions Px means that a positive voltage is applied to the pixel liquid crystals included in the pixel forming portions Px during a frame (specifically, a positive voltage relative to the common electrode Ec is applied to the pixel electrodes Ep), and the symbol “−” assigned to pixel forming portions Px means that a negative voltage is applied to the pixel liquid crystals included in the pixel forming portions Px during the frame (specifically, a negative voltage relative to the common electrode Ec is applied to the pixel electrodes Ep); the symbols “+” and “−” assigned to the pixel forming portions Px represent a polarity pattern in the pixel matrix. The present embodiment employs a dot inversion drive scheme, which is a drive scheme in which the polarity of a voltage applied to the pixel liquid crystal is inverted every two vertically/horizontally adjacent pixel matrices and is also inverted every frame. Note that instead of this, it is possible to employ a line inversion drive scheme, which is a drive scheme in which the polarity of a voltage applied to the pixel liquid crystal is inverted every row.

<1.4 Configuration and Operation of the Scanning Signal Line Drive Circuit>

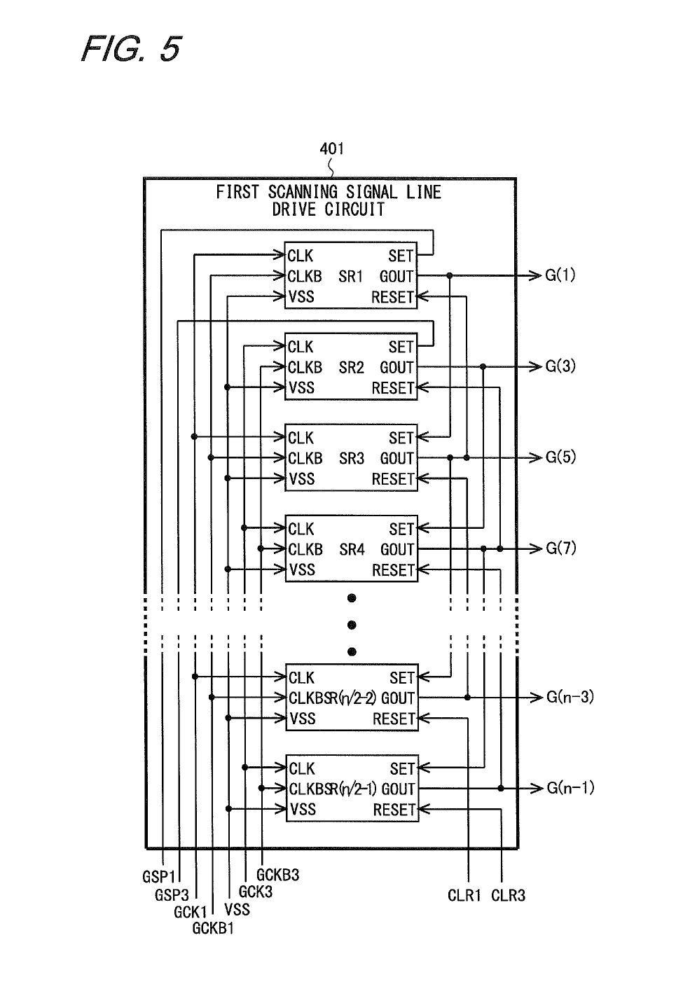

FIG. 5 is a block diagram illustrating in detail the configuration of the first scanning signal line drive circuit. Note that the configuration of the second scanning signal line drive circuit 402 is approximately the same in detail as the configuration of the first scanning signal line drive circuit 401, except for the scanning signal lines connected and the contents of the signals, and therefore, any detailed description thereof will be omitted herein.

The first scanning signal line drive circuit 401 shown in FIG. 5 consists of two shift register circuits including bistable circuits SR1 to SRk (where k is a natural number such as 1≦k≦(n/2−1); n is an even number), which are flip-flop circuits or suchlike. In FIG. 5, although the entirety of each of the two shift register circuits is not shown for the sake of easy viewing, the shift register circuit that consists of the odd-numbered bistable circuits from among the bistable circuits SR1 to SRk will be referred to herein as the first shift register circuit, and the shift register circuit that consists of the even-numbered bistable circuits will be referred to herein as the second shift register circuit.

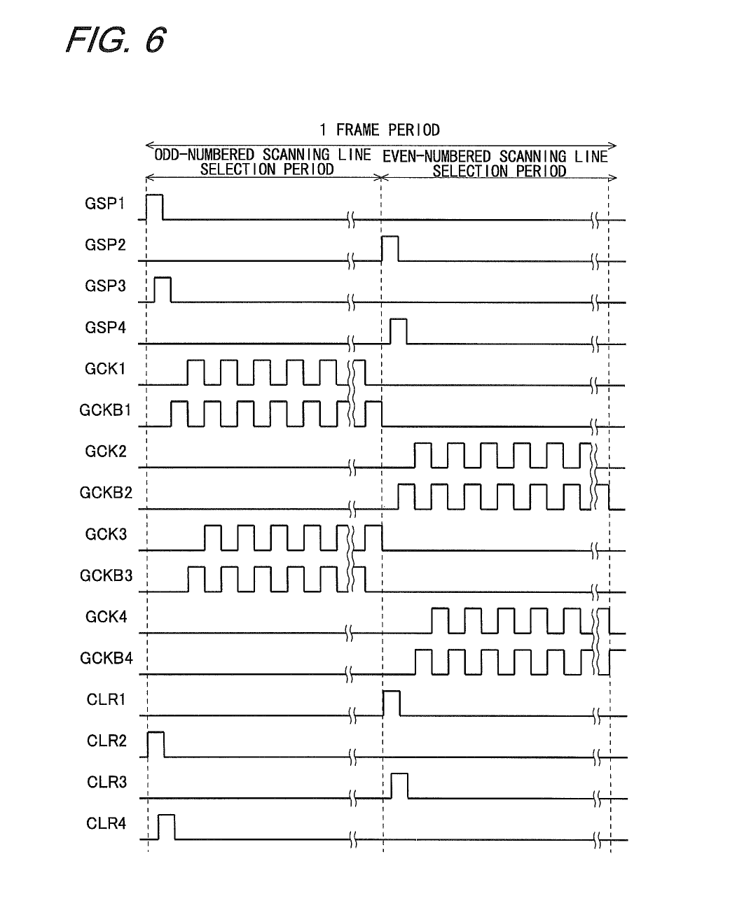

The first scanning signal line drive circuit 401 is provided with a gate signal GS1. The gate signal GS1 includes gate clock signals GCK1, GCKB1, GCK3, and GCKB3, gate start pulse signals GSP1 and GSP3, and clear signals CLR1 and CLR3. Moreover, the second scanning signal line drive circuit 402 is provided with a gate signal GS2. The gate signal GS2 includes gate clock signals GCK2, GCKB2, GCK4, and GCKB4, gate start pulse signals GSP2 and GSP4, and clear signals CLR2 and CLR4, and these signals will be described in detail later with reference to FIG. 6.

The bistable circuit SRk includes a set terminal SET, an output terminal GOUT, a reset terminal RESET, a low-power input terminal VSS, and clock input terminals CLK and CLKB. The bistable circuit SRk outputs a scanning signal G (k) to be provided to its corresponding scanning signal line, from the output terminal GOUT.

In the bistable circuit SRk (where k≧3), a scanning signal G (k−2), which is an output signal of the bistable circuit SR (k−2) in the second preceding stage, is inputted to the set terminal SET. Moreover, the gate start pulse signal GSP1 is inputted to the set terminal SET of the bistable circuit SR1, which is the first stage of the first shift register circuit, and the gate start pulse signal GSP3 is inputted to the set terminal SET of the bistable circuit SR2, which is the first stage of the second shift register circuit.

Furthermore, in the bistable circuit SRk (where k≦n/2−3), a scanning signal G (k+2), which is an output signal of the bistable circuit SR (k+2) in the second succeeding stage, is inputted to the set terminal SET. Moreover, the clear signal CLR1 is inputted to the reset terminal RESET of the bistable circuit SRk (where k=n/2−2), which is the last stage of the first shift register circuit, and the clear signal CLR3 is inputted to the reset terminal RESET of the bistable circuit SRk (where k=n/2−1), which is the last stage of the second shift register circuit.

Furthermore, the gate clock signals GCK1 and GCKB1 are inputted to the clock input terminals CLK and CLKB, respectively, of the bistable circuits SRk included in the first shift register circuit, and the gate clock signal GCK3 and GCKB3 are inputted to the clock input terminals CLK and CLKB, respectively, of the bistable circuits SRk included in the second shift register circuit.

Furthermore, a low-power voltage, which is a low-potential-side power supply voltage for the bistable circuit SRk, is inputted to each of the low-power input terminals VSS of the bistable circuits SRk included in the first and second shift register circuits.

Note that the foregoing descriptions apply to the second scanning signal line drive circuit 402 as well and any descriptions of the second scanning signal line drive circuit 402 will be omitted because the second scanning signal line drive circuit 402 has a similar configuration and is simply provided with the gate signal GS2 including signals that are similar to and correspond to the signals included in the gate signal GS1, i.e., gate clock signals GCK2, GCKB2, GCK4, and GCKB4, gate start pulse signals GSP2 and GSP4, and clear signals CLR2 and CLR4 are provided in place of the gate clock signals GCK1, GCKB1, GCK3, and GCKB3, the gate start pulse signals GSP1 and GSP3, and the clear signals CLR1 and CLR3. In the case where the bistable circuits and the trunk lines are formed on the glass substrate, as described above, the wiring area slightly increases in a direction vertical to the direction in which the bistable circuits are arranged.

FIG. 6 provides waveform charts for the signals related to the first scanning signal line drive circuit 401. Note that for easy viewing and for convenience of explanation, the waveforms in the figure are shown as being equal in pulse width, but in actuality, the gate start pulse signals are greater in pulse width than the gate clock signals, and well-known adjustment periods such as blanking periods are set.

As shown in FIG. 6, one frame period is halved into odd-numbered and even-numbered scanning line selection periods, and the gate start pulse signals are provided at the beginning of these selection periods, more specifically, the gate start pulse signals GSP1 and GSP3 are provided at the beginning of the odd-numbered scanning line selection period, and the gate start pulse signals GSP2 and GSP4 are provided at the beginning of the even-numbered scanning line selection period.

Initially, in the odd-numbered scanning line selection period, the gate clock signal GCK1 is set to ON potential, and then the gate clock signal GCK3 is set to ON potential with different timing from (i.e., so as not to be ON at the same time as) the ON-potential period of the gate clock signal GCK1; such waveforms are repeated so that the gate start pulse signals GSP1 and GSP3 are shifted alternatingly, thereby outputting (i.e., activating) the scanning signals G(k), specifically in the order: the scanning signals G(1), G(3), G (5), . . . , from the output terminals GOUT of the bistable circuits SRk shown in FIG. 5. As a result, the odd-numbered scanning signal lines are selected sequentially. After all of the odd-numbered scanning signal lines are completely selected, the clear signals CLR1 and CLR3 are activated, and in the subsequent even-numbered scanning line selection period, the gate clock signals GCK1, GCKB1, GCK3, and GCKB3, the gate start pulse signals GSP1 and GSP3, and the clear signals CLR1 and CLR3 are set at OFF potential (i.e., kept in inactive state).

Here, the gate clock signals GCK1 and GCKB1 (and other corresponding gate clock signals) are in a complementary relationship in terms of phase, such that they do not overlap with respect to the period in which clock pulses are active (here, the period of high-level state), as shown in FIG. 6. Moreover, the high-level (i.e., active) voltage of each gate clock signal is denoted by VGH, and the low-level (i.e., inactive) voltage is denoted by VGL. The low-power voltage provided to the low-power input terminal VSS is equal to the low-level voltage VGL of the gate clock signal. Here, the gate clock signals GCK1 and GCK3 are in opposite phase, but it is also possible that the period in which clock pulses of one clock signal are active is included in the period in which the other clock signal is inactive (i.e., the clock duty cycle is less than ½).

Furthermore, in the even-numbered scanning line selection period, the gate clock signal GCK2 is set to ON potential, and then the gate clock signal GCK4 is set to ON potential with different timing from (i.e., so as not to be ON at the same time as) the ON-potential period of the gate clock signal GCK2; such waveforms are repeated so that the gate start pulse signals GSP2 and GSP4 are shifted alternatingly, thereby outputting (i.e., activating) the scanning signals G(k), specifically in the order: the scanning signals G(2), G(4), G (6), . . . , from the output terminals GOUT of the bistable circuits SRk. As a result, the even-numbered scanning signal lines are selected sequentially. After all of the even-numbered scanning signal lines are completely selected, the clear signals CLR2 and CLR4 are activated, and in the subsequent odd-numbered scanning line selection period, the gate clock signals GCK2, GCKB2, GCK4, and GCKB4, the gate start pulse signals GSP2 and GSP4, and the clear signals CLR2 and CLR4 are set at OFF potential (i.e., kept in inactive state).

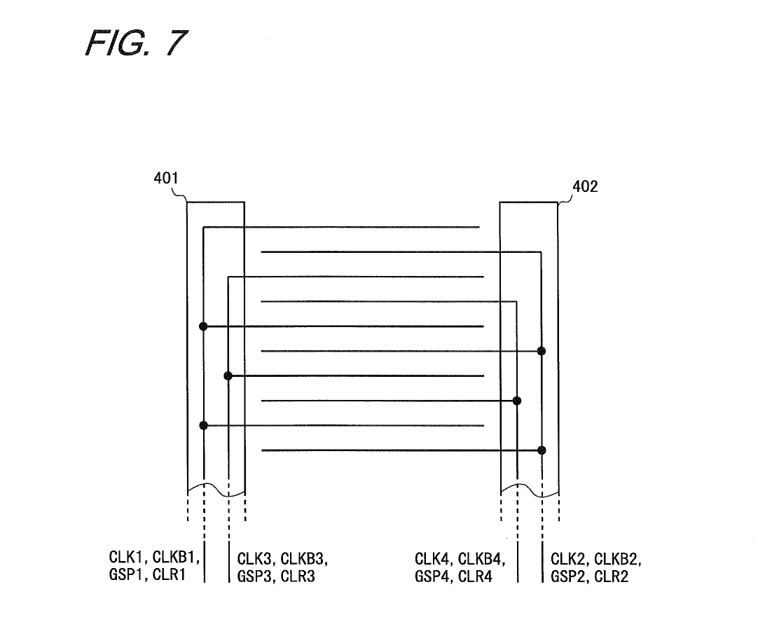

FIG. 7 is a diagram describing the selection and connections of the scanning signal lines as well as the relationship with the signals. As shown in FIG. 7, the first scanning signal line drive circuit 401 is connected to the odd-numbered scanning signal lines, and the second scanning signal line drive circuit 402 is connected to the even-numbered scanning signal lines.

Furthermore, the gate clock signals GCK1 and GCKB1, the gate start pulse signal GSP1, and the clear signal CLR1 are provided to the first shift register circuit included in the first scanning signal line drive circuit 401 and consisting of the odd-numbered bistable circuits, as described earlier. Moreover, the gate clock signals GCK3 and GCKB3, the gate start pulse signal GSP3, and the clear signal CLR3 are provided to the second shift register circuit included in the first scanning signal line drive circuit 401 and consisting of the even-numbered bistable circuits. The first and second shift register circuits are connected alternatingly to the odd-numbered scanning signal lines, and therefore, in the operation of sequentially selecting the odd-numbered scanning signal lines, the signals are provided so as to cause the first and second shift register circuits to operate alternatingly.

Furthermore, the gate clock signals GCK2 and GCKB2, the gate start pulse signal GSP2, and the clear signal CLR2 are provided to the first shift register circuit included in the second scanning signal line drive circuit 402 and consisting of the odd-numbered bistable circuits. Moreover, the gate clock signals GCK4 and GCKB4, the gate start pulse signal GSP4, and the clear signal CLR4 are provided to the second shift register circuit included in the second scanning signal line drive circuit 402 and consisting of the even-numbered bistable circuits. Note that the manner in which the even-numbered scanning signal lines are selected is similar to the above.

Accordingly, in principle, it is possible to keep the second scanning signal line drive circuit 402 from operating during the operation of the first scanning signal line drive circuit 401, and conversely, it is possible to keep the first scanning signal line drive circuit 401 from operating during the operation of the second scanning signal line drive circuit 402, resulting in reduced power consumption in the entire device.

Furthermore, the gate clock signals, the gate start pulse signals, and the clear signal provided to the first scanning signal line drive circuit 401 are supplied by an unillustrated display control circuit through the two trunk lines (corresponding to the two shift register circuits), as shown in FIG. 6. Accordingly, when compared to a typical conventional scanning signal line drive circuit including one shift register circuit, the number of bistable circuits connected to one trunk line is halved and the clock signals have lower frequencies, whereby it is possible to further reduce power consumption and suppress the influence of electromagnetic interference (EMI).

Furthermore, the present embodiment employs a dot inversion drive scheme, which is a drive scheme in which the polarity of a voltage applied to the pixel liquid crystal is inverted every two vertically/horizontally adjacent pixel matrices and is also inverted every frame, as described earlier. In the case where this drive scheme is employed, if the interlaced scanning as described above is performed, it is possible to realize one-dot inversion drive simply by performing polarity inversion once every frame. Note that this is also true for the case where the line inversion drive scheme is employed.

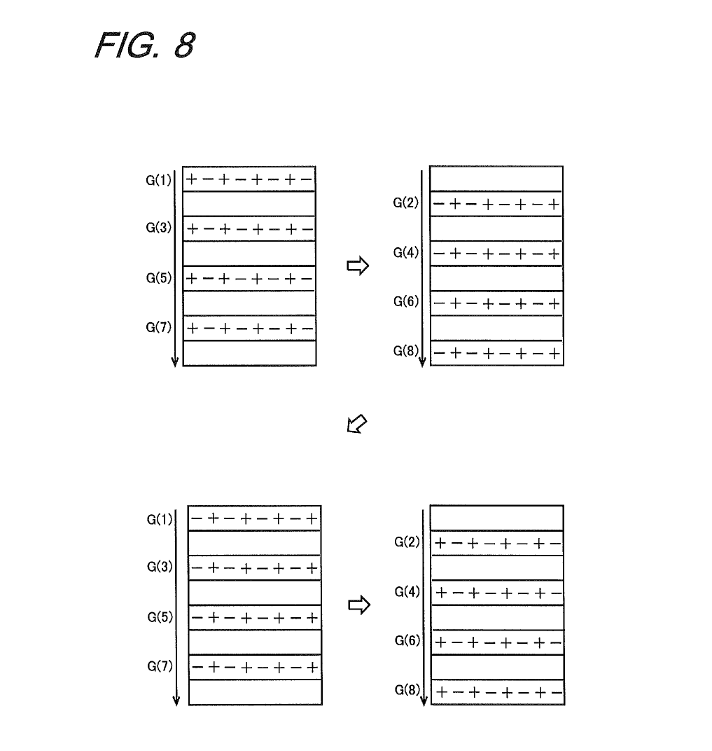

FIG. 8 is a diagram describing the operation in the one-dot inversion drive. As shown in FIG. 8, when the odd-numbered scanning lines are selected, the polarity of the drive video signals S(1), S(3), S(5), and so on is positive, the polarity of the video signals S(2), S(4), S(6), and so on is negative, and the polarities are inverted alternatingly on a pixel-by-pixel basis in the horizontal direction. In addition, when the even-numbered scanning lines are selected, the polarity of the drive video signals S(1), S(3), S(5), and so on is negative, the polarity of the video signals S(2), S(4), S(6), and so on is positive, and similarly, the polarities are inverted alternatingly on a pixel-by-pixel basis in the horizontal direction. Further, in the next frame, the polarities are opposite to the above. By doing so, it is rendered possible to realize dot inversion drive with higher display quality.

<1.5 Effects>

As described above, the present display device includes two shift register circuits in each of the right and left scanning signal line drive circuits, and the shift register circuits are driven by signals provided through their respectively different trunk lines, so that the number of bistable circuits connected to one trunk line is halved and the clock signals have lower frequencies, whereby it is possible to further reduce power consumption and suppress the influence of electromagnetic interference (EMI). Moreover, in such a configuration, the wiring area increases only slightly, and therefore, even in the case where scanning signal line drive circuits are monolithically formed on the glass substrate, it is possible to avoid a larger circuit area and an increased frame area. Further, by employing the dot inversion drive, it is rendered possible to keep video signal polarity inversion down to once every frame while realizing high display quality, and this also contributes to reduced power consumption.

### 2. Second Embodiment

<2.1 Overall Configuration and Operation>

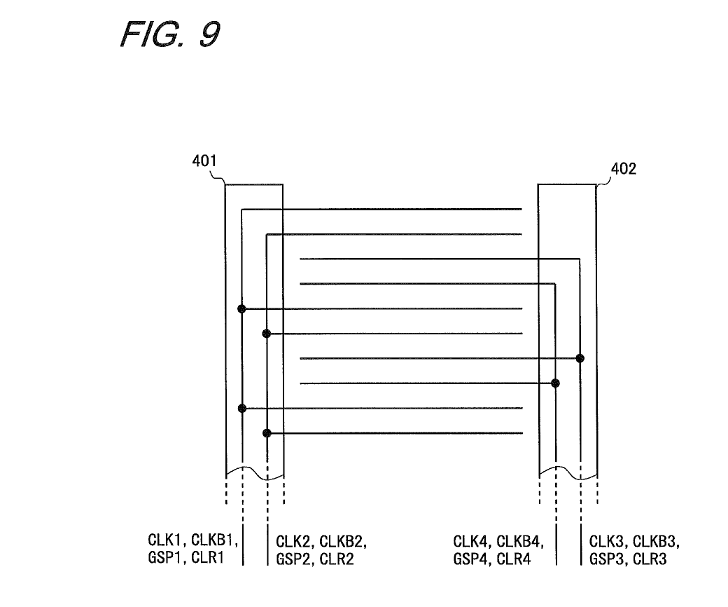

The configuration of a liquid crystal display device according to a second embodiment of the present invention is the same as that shown in FIG. 1, the configuration and other details of the liquid crystal panel 500 are the same as those shown in FIG. 3, etc., therefore, the same components are denoted by the same characters, and any detailed descriptions thereof will be omitted. In addition, the shift register circuits included in the first and second scanning signal line drive circuits 401 and 402 have the same configuration as above but operate in a slightly different manner. In relation to this, the scanning signal lines connected to the first and second scanning signal line drive circuits 401 and 402 differ from those in the first embodiment. Details will be described below with reference to FIG. 9.

FIG. 9 is a diagram describing the selection and connections of the scanning signal lines as well as the relationship with the signals. As shown in FIG. 9, unlike in the above configuration shown in FIG. 7, the first scanning signal line drive circuit 401 is connected sequentially to every other pair of scanning signal lines with the first pair consisting of the first and second scanning signal lines, and the second scanning signal line drive circuit 402 is also connected sequentially to every other pair of scanning signal lines with the first pair consisting of the third and fourth scanning signal lines.

Furthermore, as in the first embodiment, the gate clock signals GCK1 and GCKB1, the gate start pulse signal GSP1, and the clear signal CLR1 are provided to the first shift register circuit included in the first scanning signal line drive circuit 401 and consisting of the odd-numbered bistable circuits. Moreover, unlike in the first embodiment, the gate clock signals GCK2 and GCKB2, the gate start pulse signal GSP2, and the clear signal CLR2 are provided to the second shift register circuit included in the first scanning signal line drive circuit 401 and consisting of the r bistable circuits. The first and second shift register circuits are connected alternatingly to the first (i.e., upper) and second (i.e., lower) scanning signal lines included in each pair.

Furthermore, unlike in the first embodiment, the gate clock signals GCK3 and GCKB3, the gate start pulse signal GSP3, and the clear signal CLR3 are provided to the first shift register circuit included in the second scanning signal line drive circuit 402 and consisting of the odd-numbered bistable circuits. Moreover, as in the first embodiment, the gate clock signals GCK4 and GCKB4, the gate start pulse signal GSP4, and the clear signal CLR4 are provided to the second shift register circuit included in the second scanning signal line drive circuit 402 and consisting of the even-numbered bistable circuits. Similar to the above, each of the first and second shift register circuits is connected alternatingly to one of two scanning signal lines included in each pair.

Accordingly, in the operation of sequentially selecting the odd-numbered scanning signal lines, the signals are provided such that the first shift register circuit included in the first scanning signal line drive circuit 401 and the first shift register circuit included in the second scanning signal line drive circuit 402 are caused to operate alternatingly. Moreover, as for the even-numbered scanning signal lines, the signals are provided similarly such that the second shift register circuits included in the first and second scanning signal line drive circuits 401 and 402 are caused to operate alternatingly.

Therefore, not only the first and second scanning signal line drive circuits 401 and 402 are caused to operate alternatingly, but also every other bistable circuit in the direction of arrangement operates in the first and second scanning signal line drive circuits 401 and 402 (i.e., every other stage of the shift register operates). Accordingly, the positions of the bistable circuits in operation are dispersed, so that the intensity of electromagnetic wave per unit area decreases. Thus, when compared to the first embodiment, it is possible to further suppress the influence of electromagnetic interference (EMI).

<2.2 Effects>

As described above, as in the first embodiment, the number of bistable circuits connected to one trunk line in the display device is halved and the clock signals have lower frequencies, whereby it is possible to further reduce power consumption and suppress the influence of electromagnetic interference (EMI). Further, when compared to the configuration of the first embodiment, the positions of the bistable circuits in operation are dispersed, and therefore, it is possible to further suppress the influence of electromagnetic interference (EMI).

Note that as in the first embodiment, by employing the dot inversion drive, it is rendered possible to keep video signal polarity inversion down to once every frame while realizing high display quality, and this also contributes to reduced power consumption.

### 3. Third Embodiment

<3.1 Overall Configuration and Operation>

The configuration of a liquid crystal display device according to a third embodiment of the present invention is the same as that shown in FIG. 1, the configuration and other details of the liquid crystal panel 500 are the same as those shown in FIG. 3, etc., therefore, the same components are denoted by the same characters, and any detailed descriptions thereof will be omitted. In addition, the configurations of the scanning signal line drive circuits are the same as those in the first or second embodiment, and therefore, any descriptions thereof will be omitted.

Unlike the first and second embodiments, the present embodiment employs a so-called time-division drive scheme in which the video signal lines Ls on the liquid crystal panel are divided into a plurality of groups of three video signal lines, such that each video signal line group (each set of three video signal lines Ls) are connected to one output terminal of a video signal line drive circuit 300 via a set of three analog switches. In this manner, the output terminals of the video signal line drive circuit 300 are in one-to-one correspondence with the video signal line groups, so as to be connected to respective video signal line groups (respective sets of three video signal lines Ls) via respective sets of three analog switches. Accordingly, each set of three analog switches constitutes a change-over switch, so that each output terminal of the video signal line drive circuit 300 is connected to three video signal lines in the video signal line group that corresponds thereto, in a time-division manner.

In the case of such time-division drive, to invert the polarities of horizontally adjacent pixel matrices, it is necessary to invert the polarities at the output terminals of the video signal line drive circuit 300 between the first and second periods and between the second and third periods within one horizontal period, and also between the third period and the next first period, resulting in increased power consumption, and it is also necessary to set higher drive power for the video signal line drive circuit 300. Accordingly, a 3-dot inversion drive scheme is employed in which the polarity of a voltage applied to the pixel liquid crystal is inverted every row and also every three horizontally adjacent pixel matrices and every frame.

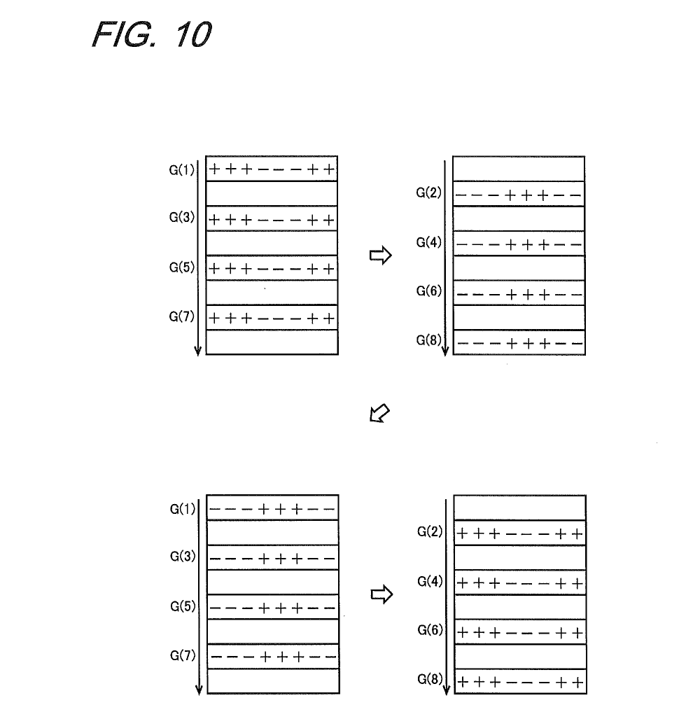

FIG. 10 is a diagram describing the operation in the three-dot inversion drive. As shown in FIG. 10, when the odd-numbered scanning lines are selected, the polarity of the drive video signals S (1), S (2), and S (3) is positive, the polarity of the video signals S (4), S (5), and S (6) is negative, and also the polarities are inverted every three pixels in the horizontal direction. In addition, when the even-numbered scanning lines are selected, the polarity of the drive video signals S (1), S (2), and S (3) is negative, the polarity of the video signals S(4), S(5), and S(6) is positive, and also the polarities are inverted every three pixel in the horizontal direction. Further, in the next frame, the polarities are opposite to the above. By doing so, it is rendered possible to realize dot inversion drive with higher display quality.

<3.2 Effects>

As described above, in the case where the time-division drive scheme is employed, the present display device maintains high-quality display by using the three-dot inversion drive scheme, and as in the first or second embodiment, the number of bistable circuits connected to one trunk line is halved and the clock signals have lower frequencies, whereby it is possible to further reduce power consumption and suppress the influence of electromagnetic interference (EMI).

### 4. Variants

The above embodiments have been described with respect to the examples where flip-flop circuits are used as the bistable circuits that function as shift registers, but circuitry that realizes similar operations to the above can be configured using well-known bistable circuits, such as other bistable circuits and latch circuits (e.g., D-latch circuits).

In the above embodiments, the signals have been described as being active when they are in ON state, but depending on the circuit configuration, the signals may be active when they are in OFF state, and the potential of an active signal is not limited specifically.

Typically, the one-dot inversion drive scheme is employed in the first and second embodiments, and the three-dot inversion drive scheme is employed in the third embodiment, but the inversion drive method employed herein may be a line inversion drive scheme or even an n-dot inversion drive scheme (where n is a natural number) which allows higher quality display.

In the above embodiments, liquid crystal elements that readily achieve the above effects are used because polarity inversion drive is required, but such liquid crystal elements are not limiting, and organic EL (Electro Luminescence) elements, semiconductor LEDs (Light Emitting Diodes), FED (Field Emission Display) elements, and the like can be used in any active-matrix display devices with video signal lines.

### INDUSTRIAL APPLICABILITY

The present invention is applied to display devices such as active-matrix liquid crystal display devices and their scanning signal line drive circuits, and is particularly suitable for display devices and their scanning signal line drive circuits for which low power consumption is required.

### DESCRIPTION OF THE REFERENCE CHARACTERS

10 TFT (thin-film transistor)
200 display control circuit
300 video signal line drive circuit
401 first scanning signal line drive circuit
402 second scanning signal line drive circuit
500 liquid crystal panel
Px pixel forming portion (pixel)
SCK source clock signal
SSP source start pulse signal
GS1, GS2 gate signal
GSP1 to GSP4 gate start pulse signal
CLR1 to CLR4 clear signal
G(1) to G(n) scanning signal
GCK1 to GCK4, GCKB1 to GCKB4 gate clock signal

1. A scanning signal line drive circuit for performing interlaced scanning to sequentially drive a plurality of scanning signal lines included in an active-matrix display device such that odd-numbered scanning signal lines are driven sequentially with corresponding scanning signals in a first period and even-numbered scanning signal lines are driven sequentially with corresponding scanning signals in a second period, the circuit comprising:
a first circuit group connected to a first scanning signal line group on a first-end side of the scanning signal lines divided into two groups, one being the first scanning signal line group, the other being a second scanning signal line group; and
a second circuit group connected to the second scanning signal line group on a second-end side of the scanning signal lines, wherein,
the first circuit group includes first and second shift register circuits alternatingly connected on the first-end side to the scanning signal lines included in the first scanning signal line group,
the second circuit group includes third and fourth shift register circuits alternatingly connected on the second-end side to the scanning signal lines included in the second scanning signal line group,
two of the first through fourth shift register circuits sequentially drive the odd-numbered scanning signal lines in the first period, and
the remaining two of the first through fourth shift register circuits sequentially drive the even-numbered scanning signal lines in the second period.

2. The scanning signal line drive circuit according to claim 1, wherein,
the first scanning signal line group includes only the odd-numbered scanning signal lines,
the second scanning signal line group includes only the even-numbered scanning signal lines,
the first and second shift register circuits alternatingly and sequentially drive the odd-numbered scanning signal lines in the first period, and
the third and fourth shift register circuits alternatingly and sequentially drive the even-numbered scanning signal lines in the second period.

3. The scanning signal line drive circuit according to claim 1, wherein,
when the scanning signal lines are sequentially grouped into pairs of adjacent lines with the first pair consisting of the first and second scanning signal lines, the first scanning signal line group includes only odd-numbered pairs of scanning signal lines,
the second scanning signal line group includes only even-numbered pairs of scanning signal lines,
the first and third shift register circuits alternatingly and sequentially drive the odd-numbered scanning signal lines in the first period, and
the second and fourth shift register circuits alternatingly and sequentially drive the even-numbered scanning signal lines in the second period.

4. The scanning signal line drive circuit according to claim 2, wherein the first through fourth shift register circuits are externally provided with either control signals or power supply potentials or both through respectively different wiring lines.

5. The scanning signal line drive circuit according to claim 1, wherein the scanning signal lines are integrally formed with the first and second circuit groups on the same substrate.

6. An active-matrix display device, comprising:
a scanning signal line drive circuit of claim 1;
a plurality of video signal lines arranged so as to cross the scanning signal lines;
a plurality of pixel forming portions arranged in a matrix corresponding to intersections of the video signal lines and the scanning signal lines; and
a video signal line drive circuit for driving the video signal lines to transmit data signals to the pixel forming portions, wherein,
the video signal line drive circuit drives the video signal lines such that voltages provided to the video signal lines are inverted in polarity between the first and second periods.

7. The scanning signal line drive circuit according to claim 3, wherein the first through fourth shift register circuits are externally provided with either control signals or power supply potentials or both through respectively different wiring lines.
